(19) United States
(12) Patent Application Publication
(10) Pub. No.: US 2025/0147725 A1
(43) Pub. Date: May 8, 2025

(54) Accumulator, Method for Accumulator and Chip Circuit

(71) Applicant: Shenzhen Corerain Technologies Co., Ltd., Shenzhen (CN)

(72) Inventors: Chenchen Lu, Shenzhen (CN); Kuen Hung Tsoi, Shenzhen (CN); Xinyu Niu, Shenzhen (CN)

(21) Appl. No.: 18/650,256

(22) Filed: Apr. 30, 2024

(30) Foreign Application Priority Data
Nov. 3, 2023 (CN) 202311452209.7

(51) Int. Cl. G06F 7/499

(52) U.S. Cl. CPC G06F 7/49915

(57) ABSTRACT

The present application provides an accumulator, a method for the accumulator and a chip circuit. The accumulator includes an accumulation execution module, a difference correction module and a first register, wherein: the accumulation execution module is used to perform accumulation operations on input data of floating point type, and the truncated data in each operation is reserved as truncation error, and the truncation error is fed back to the difference correction module; the difference correction module uses the fed-back truncation error to perform superposition calculation on the external input data, and outputs the superimposed input data to the accumulation execution module; the first register is used to buffer the accumulation result of the accumulation execution module, and the accumulation result is sent back to the accumulation execution module through a feedback channel. It is possible to improve the calculation efficiency while improving the accumulation accuracy of floating point numbers.

### CROSS REFERENCE TO RELATED APPLICATIONS

The present application claims the benefit of Chinese Patent Application No. 202311452209.7 filed on Nov. 3, 2023, the contents of which are incorporated herein by reference in their entirety.

### TECHNICAL FIELD

The present invention relates to the field of chip circuit technology, and in particular to an accumulator, a method for the accumulator, and a chip circuit.

### BACKGROUND TECHNIQUE

A floating-point number is composed of a sign bit, an exponent, and a mantissa. When two floating-point numbers are added, if the exponents of the two data are different, there will be a computational precision error caused by data shifting and discarding during the operation. Such errors are inevitable in floating-point number addition operations. In particular, when the numerical values of two floating-point numbers differ significantly, there will be a phenomenon that the data cannot be effectively added, that is, the result of the calculation equals the larger of the two addends. This phenomenon is acceptable in a single floating-point addition operation, but if it occurs in an accumulator, this calculation error will continue to accumulate, causing the final result to deviate greatly from the true value.

To prevent the continuous error accumulation from floating-point addition during accumulation operations, it is common to convert the data into a higher-precision format and then perform the accumulation calculation. Converting data into a higher-precision format typically involves increasing the data bit width of the accumulator by a factor of more than two. For example, when the data format of the addend is FP32, converting it to FP64 before performing the accumulation calculations results in a transition from 32-bit FP32 format to 64-bit format. Such a conversion, however, leads to a corresponding twofold or even greater increase in both computational resources and power consumption. When there is an excessive amount of data to be accumulated, it will consume more resources, leading to resource waste. Alternatively, the data can be arranged based on their numerical values before calculation and then perform accumulation from the smallest to the largest numbers. However, when the volume of data is large, arranging the data will consume a significant amount of time. In some real-time application scenarios, it is even impossible to arrange all the data. Another approach is to perform accumulation in segments of the data. Using programming languages or algorithms to implement accumulation is also a common processing method, which is convenient for CPU computation. Nevertheless, when using the CPU for computation, multiple additions need to be executed, resulting in several times the computation time.

For this reason, a technical solution is needed that can improve the calculation efficiency while improving the accuracy of floating-point number accumulation.

### Contents of the Invention

The present application aims to provide an accumulator, a method for the accumulator, and a computation device, which can achieve floating-point number accumulation using a simplified chip circuit, while simultaneously enhancing the accuracy of floating-point number accumulation and improving operational speed.

According to an aspect of the present application, an accumulator for floating-point number accumulation is provided, including an accumulation execution module, a difference correction module and a first register, wherein:

the accumulation execution module is used to perform an accumulation operation on a floating-point type input data, and a truncated data in each operation is reserved as a truncation error, and the truncation error is fed back to the difference correction module;

the difference correction module uses the fed-back truncation error to perform a superposition calculation on an external input data, and outputs a superimposed input data to the accumulation execution module; and the first register is used to buffer an accumulation result of the accumulation execution module, and the accumulation result is sent back to the accumulation execution module through a feedback channel.

According to some embodiments, the accumulator further includes: a second register for buffering the truncation error and providing the truncation error to the difference correction module.

According to some embodiments, the accumulator further includes: a third register for buffering the superimposed input data and providing the superimposed input data to the accumulation execution module.

According to some embodiments, the accumulation execution module includes:

an adder used to perform an addition operation on the accumulation result and the superimposed input data; and

a truncation error register used to store the truncation error calculation result.

According to some embodiments, the accumulation execution module is configured to align the accumulation result with the superimposed input data;

store a truncated mantissa during the alignment as the truncation error; and perform an alignment addition on the truncated floating-point data, and buffer the calculation result as the accumulation result into the first register.

According to some embodiments, the accumulation execution module is configured to in response to the accumulation result exceeding a number of alignment bits, perform a normalized truncation on the accumulation result, that is, in the accumulation result, truncate a high-bit data of corresponding alignment bits as the accumulation result and store the accumulation result in the first register;

concatenate a low bit truncated after the normalized truncation with a mantissa truncated by an alignment truncation, and store a result data obtained by the concatenation in the second register as the truncation error.

According to the present application, a method for an accumulator is provided, including:

calculating an accumulation result of a floating point data and obtaining a truncation error calculation result;

feeding the truncation error back to an input end; and

using the fed-back truncation error to perform a superposition calculation on an external input data, and outputting the superimposed input data for accumulation calculation.

According to some embodiments, the step of calculating an accumulation result of a floating point data and obtaining a truncation error calculation result includes:

during the accumulation, performing an alignment addition on the accumulation result and the superimposed input data, using a calculation result as the accumulation result, and using a mantissa truncated by the alignment as the truncation error;

in response to there being a carry in the accumulation result, performing a normalized truncation on the data, and concatenating a low bit truncated after the normalized truncation with the mantissa truncated by the alignment truncation to form the truncation error; and

only after the accumulation of all input data is completed, performing a rounding operation on the accumulation result according to the user's requirements.

The present application further provides a chip circuit which can implement all the functions of the above accumulator.

According to another aspect of the present application, a computation device is provided, including:

a processor; and

a memory storing a computer program that, when executed by the processor, causes the processor to execute the method according to any one of the above.

According to yet another aspect of the present application, a non-transitory computer-readable storage medium is provided, which stores computer-readable instructions thereon. When the instructions are executed by a processor, the processor is caused to perform any of the above methods.

According to the embodiment of the present application, the input data undergoes truncation error superposition calculation utilizing the difference correction module, followed by the adder in the accumulation execution module performing accumulation calculations on the superimposed input data. Simultaneously, the truncation error register within the accumulation execution module stores the truncation error, enabling the new truncation error value to be superimposed on the next input data. Such a circular process enhances the accuracy of accumulation calculations. Within the accumulation execution module, a simple circuit for data truncation and concatenation replaces the traditional rounding circuit unit, thereby simplifying the calculation circuit and speeding up operations. Upon completion of accumulation, the output result data is rounded to meet the user's requirements, providing a more user-friendly experience.

According to the embodiment of the present application, through the addition operation of floating-point numbers, a truncation error is obtained by utilizing a truncation error register to perform calculations on the truncated mantissa. Subsequently, the truncation error is used to perform superimposition calculation on the next input data, thereby eliminating the errors resulting from rounding in traditional alignment addition, as well as the error accumulation due to the increasing number of accumulated data. This significantly enhances the accumulation accuracy of floating-point numbers.

It should be understood that the above general description and the following detailed description are only exemplary and do not limit the present application.

### DESCRIPTION OF THE DRAWINGS

In order to explain the technical solutions in the embodiments of the present application more clearly, the drawings needed to be used in the description of the embodiments will be briefly introduced below.

FIG. 1 shows a device diagram of an accumulator according to an example embodiment.

FIG. 2 shows a device diagram of the accumulator according to another example embodiment.

FIG. 3A shows a schematic diagram of an accumulation principle according to an example embodiment.

FIG. 3B shows a schematic diagram of the accumulation principle according to another example embodiment.

FIG. 4 shows a method flow diagram for an accumulator according to an example embodiment.

FIG. 5 shows a block diagram of a computation device according to an exemplary embodiment.

### DETAILED DESCRIPTION

Exemplary embodiments will now be described more fully with reference to the accompanying drawings. However, exemplary embodiments may be embodied in various forms and should not be construed as being limited to the embodiments described herein. Instead, these embodiments are provided so that this disclosure will be thorough and complete, and will fully convey the concepts of the exemplary embodiments to those skilled in the art. The same figures shown in the drawings represent the same or similar parts, and thus their repeated description will be omitted.

Furthermore, the described features, structures or characteristics may be combined in any suitable manner in one or more embodiments. In the following description, many specific details are provided to give a thorough understanding of embodiments of the present application. The technical solutions presented in this application may be practiced without some of the specific details or may utilize alternative methods, components, devices, steps, and so on, as those skilled in the art will recognize. In other cases, commonly known methods, apparatuses, implementations, or operations have been omitted or described briefly to prevent obscuring the core aspects of the present application.

The block diagrams shown in the drawings are functional entities only and do not necessarily correspond to physically independent entities. That is, these functional entities may be implemented in software form, or implemented in one or more hardware modules or integrated circuits, or implemented in different networks and/or processor devices and/or microcontroller devices.

The flowcharts shown in the drawings are only illustrative, and do not necessarily include all contents and operations/steps, nor must they be performed in the order described. For example, some operations/steps can be decomposed, and some operations/steps can be merged or partially merged, so the actual order of execution may change according to the actual situation.

It should be understood that although terms such as “first”, “second”, and “third” may be used in this disclosure to describe various components, these components should not be limited by these terms. These terms are used to distinguish one component from another. Therefore, the first component discussed below may be referred to as the second component without deviating from the teachings of the present application. As used herein, the term “and/or” includes any and all combinations of one or more of the associated listed items.

The user information (including but not limited to user device information, user personal information, etc.) and data (including but not limited to data used for analysis, stored data, displayed data, etc.) involved in the present application are information and data that have been authorized by users or fully authorized by all parties. The collection, use, and processing of relevant data need to comply with relevant laws, regulations, and standards in relevant countries and regions, and provide corresponding operation entrances for users to choose to authorize or refuse.

It is understood by those skilled in the art that the accompanying drawings are only schematic diagrams of exemplary embodiments, and the modules or processes depicted in the drawings are not necessarily essential for implementing the present application. Therefore, they cannot be used to limit the scope of protection of the present application.

When two floating-point numbers are added, if the exponents of the two data are different, there will be a computational precision error caused by data shifting and discarding truncated mantissa during the operation. Such errors are inevitable in floating-point number addition operations. In particular, when the numerical values of two floating-point numbers differ significantly, there will be a phenomenon that the data cannot be effectively added, that is, the result of the calculation equals the larger of the two addends. This phenomenon is acceptable in a single floating-point addition operation, but if it occurs in an accumulator, this calculation error will continue to accumulate, causing the final result to deviate greatly from the true value.

To prevent the continuous error accumulation from floating-point addition during accumulation operations, it is common to convert the data into a higher-precision format and then perform the accumulation calculation. Converting data into a higher-precision format typically involves increasing the data bit width of the accumulator by a factor of more than two. Such a conversion, however, leads to a corresponding twofold or even greater increase in both computational resources and power consumption. When there is an excessive amount of data to be accumulated, it will consume more resources, leading to resource waste. Alternatively, the data can be arranged in ascending order based on their numerical values before calculation and then perform accumulation from the smallest to the largest numbers. However, when the volume of data is large, arranging the data will consume a significant amount of time. In some real-time application scenarios, it is even impossible to arrange all the data. Another approach is to perform accumulation in segments of the data. Using programming languages or algorithms to implement accumulation is also a common processing method, which is convenient for CPU computation. Nevertheless, when using the CPU for computation, multiple additions need to be executed, resulting in several times the computation time.

To this end, the present application proposes an accumulator, a method for the accumulator, and a computation device, which can improve calculation efficiency while improving floating-point number accumulation accuracy.

According to the embodiment, the input data undergoes truncation error superposition calculation, followed by performing accumulation calculations on the superimposed input data. Simultaneously, the truncation error is calculated, enabling the new truncation error value to be superimposed on the next input data. Such a circular process enhances the accuracy of accumulation calculations. Within the accumulation execution module, a simple circuit for data truncation and concatenation replaces the traditional rounding circuit unit, thereby simplifying the calculation circuit and speeding up operations.

Example embodiments of the present application are described below with reference to the accompanying drawings.

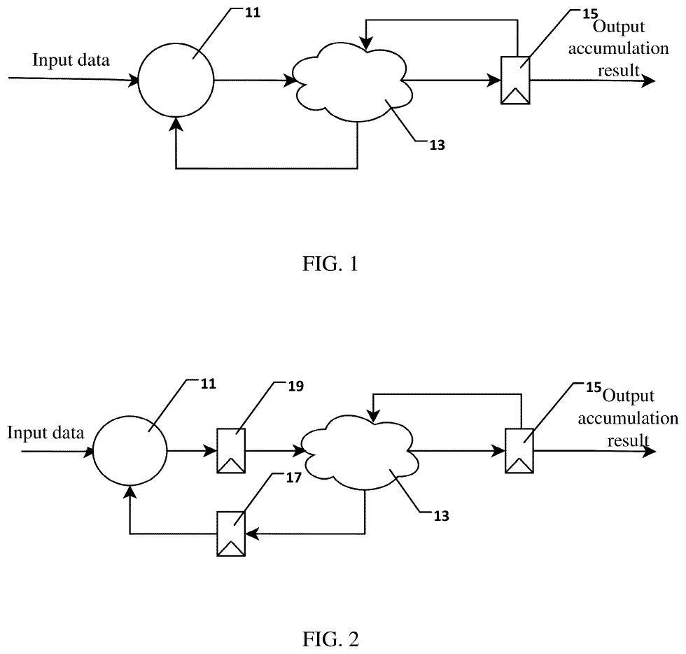

FIG. 1 shows a device diagram of an accumulator according to an example embodiment.

Referring to FIG. 1, an accumulator according to an example embodiment includes an accumulation execution module 13, a difference correction module 11 and a first register 15. This accumulator can be used to accumulate floating point numbers.

As shown in FIG. 1, the accumulation execution module 13 according to an example embodiment is used to perform an accumulation operation on the superimposed input data. The truncated data in each operation is reserved as the truncation error, and the truncation error is fed back to the difference correction module 11.

According to certain embodiments, the accumulation execution module 13 receives data from the difference correction module 11, and calculates both the accumulation result and truncation error of the floating-point data. For instance, the initial accumulation result is 0. Upon receiving input data for the first time, the accumulation result becomes the currently received input data, and the truncation error is 0. The calculated error is then fed back to the difference correction module 11, which is used for correcting the subsequent input data.

The difference correction module 11 uses the fed-back truncation error to perform superposition calculation on the external input data, and outputs the superimposed input data to the accumulation execution module 13.

According to certain embodiments, the difference correction module receives external input data and uses the fed-back truncation error to perform a superposition calculation on this data. The adder in the difference correction module 11 is used to add (or subtract) the input data and the error value. The resulting superimposed input data is then output to the accumulation execution module 13 for further accumulation operations.

The first register 15 is used to buffer the accumulation result of the accumulation execution module 13, and the accumulation result is sent back to the accumulation execution module 13 through a feedback channel.

According to certain embodiments, the first register 15 is used to buffer the accumulation result of the accumulation execution module 13. The accumulation result is sent back to the accumulation execution module 13 through the feedback channel as the addend for the next addition calculation.

According to certain embodiments, once the next input data is input into the accumulator, it is sent to the difference correction module 11 for truncation error superposition. The superimposed input data is then fed into the accumulation execution module 13. This module performs both the accumulation calculation and the truncation error calculation. The result of the accumulation calculation is stored in the first register 15, which is then used for feedback to the accumulation execution module 13 to update the accumulation result. The truncation error calculation result is fed back to the difference correction module 11, which is used for subsequent superposition on the input data.

FIG. 2 shows a device diagram of the accumulator according to another example embodiment.

As shown in FIG. 2, the accumulator according to another example embodiment may further include: a second register 17 for buffering the truncation error calculation result and providing the truncation error to the difference correction module; a third register 19 for buffering the superimposed input data and providing the superimposed input data to the accumulation execution module.

According to certain embodiments, the second register 17 is used to buffer the error calculation result and provide the error calculation result to the difference correction module; and the third register 19 is used to buffer the superimposed input data and provide the superposed input data to the accumulation execution module. In computer hardware, registers are very important components. They can be used to store and transfer data as well as buffer data. If there is no register, the error value output by the accumulation execution module will be directly fed back to the difference correction module. When the timing does not converge well (i.e., when it is challenging to meet the required timing), this could lead to inaccurate calculation results. Therefore, it becomes necessary to add a second register 17 and a third register 19 to facilitate easier convergence of the circuit timing. The speed of a register buffer significantly surpasses that of memory, which can enhance the speed at which the CPU accesses data. This, in turn, improves the performance of the computer and accelerates the accumulation process.

According to certain embodiments, in practical application scenarios, if the bit width of the data that needs to be accumulated is relatively small, and the timing of the circuit itself easily converges, then it may be possible to choose not to add the second register 17 and the third register 19, thereby further simplifying the circuit.

According to certain embodiments, the input data undergoes error superposition in the difference correction module 11. The superimposed input data is then buffered in the third register 19. When timing requirements are met, this superimposed input data is transmitted to the accumulation execution module 13 for further accumulation calculations and truncation error value calculation.

According to certain embodiments, the accumulation execution module 13 outputs the truncation error and buffers it into the second register 17, and then inputs the truncation error in the second register 17 into the difference correction when timing requirements are met. The difference correction module 11 uses the error value to superimpose the next input data.

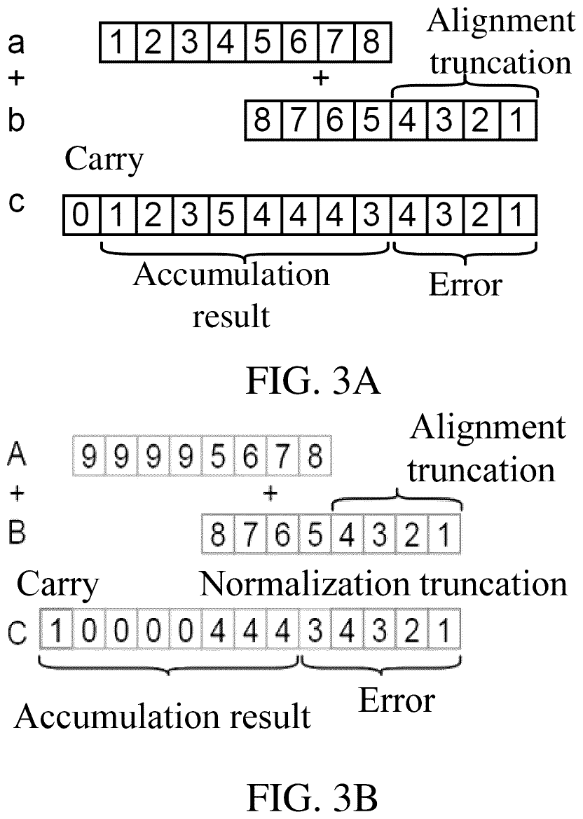

FIG. 3A shows a schematic diagram of an accumulation principle according to an example embodiment.

Referring to FIG. 3A, the accumulation execution module according to an example embodiment includes: an adder used to perform an addition operation on the accumulation result and the superimposed input data; and a truncation error register used to store the truncation error calculation results.

According to certain embodiments, the adder is used to perform an addition operation on the superimposed input data and the accumulation result returned in the first register, and truncate the mantissa into the truncation error register as the truncation error calculation results. The truncation error value is then returned to the difference correction module to superimpose the input data. This avoids the issue of reduced result accuracy caused by discarding trailing data during the floating-point number alignment shift.

According to certain embodiments, the truncation error register is used to store the truncation error, and the mantissa, truncated after alignment, is input into the truncation error register. If an overflow occurs in the accumulation result during the accumulation process, the accumulation result is normalized and truncated, discarding the lower-order mantissa. The data normalized truncation error and the alignment truncation error are added together as the truncation error and stored in the second register. The second register then returns the truncation error to the difference correction module.

In this way, during each accumulation and normalization for data, no rounding operation is performed, thereby avoiding the reduction in accuracy of the accumulation results caused by rounding operations in multiple accumulation processes.

According to example embodiments, the accumulation execution module is configured to: align the accumulation result and the superimposed input data; store the mantissa that is truncated during the alignment process as the truncation error; and add the truncated floating-point data after alignment. The calculation result is then stored in the first register as the accumulation result.

According to certain embodiments, aligning floating-point data refers to adjusting two floating-point numbers to the same exponent in order to perform addition and subtraction operations. When the exponents of the two floating-point numbers involved in the operation are different, an alignment operation needs to be performed on them. In floating-point addition and subtraction operations, to avoid loss of precision during the operations, the decimal places of the two floating-point numbers are adjusted to the same scale of digits through data alignment. For example, when adding two floating-point numbers 3.14×10² and 2.71×10⁵, if no alignment operation is performed, the calculation result may suffer from a loss of precision, resulting in inaccurate results. Therefore, before performing floating-point addition and subtraction operations, an alignment operation is usually performed first to ensure the accuracy of the calculation results.

According to certain embodiments, the specific implementation of data alignment is usually determined by comparing the exponent difference between the two floating-point numbers. If the exponent difference between two floating-point numbers does not exceed one unit, then there is no need to perform an alignment operation. However, if the exponent difference exceeds one unit, then the mantissa of the floating-point number with the smaller exponent needs to be shifted left or right, so that its exponent matches that of the floating-point number with the larger exponent.

According to certain embodiments, the unaligned mantissa of the floating-point data is truncated. This truncation can be implemented through a simple logic circuit, which not only improves the computation speed but also simplifies the hardware circuit.

According to some example embodiments, as shown in FIG. 3A, ‘a’ and ‘b’ are respectively the accumulation result and/or the input data after the superposition. Both ‘a’ and ‘b’ have a mantissa bit width of 8 bits. The data alignment is performed on data ‘a’ and ‘b’. After aligning the data, the lower 4 bits of data ‘b’ are excluded from the calculation and are truncated and stored in the truncation error register. The truncated data is then accumulated to obtain the accumulation result. Referring to FIG. 3A, the accumulation result ‘c’ is floating-point data with an 8-bit mantissa. At this point, the accumulation calculation result is the output of the adder, and the final error equals the truncation error shown in the figure.

FIG. 3B shows a schematic diagram of the accumulation principle according to another example embodiment.

As shown in FIG. 3B, the accumulation execution module according to another example embodiment is configured to: if the accumulation result exceeds a number of alignment bits, perform truncation on the accumulation result in normalization, truncate a high-bit data of corresponding alignment bits as the accumulation result and store the accumulation result in the first register, concatenate a low bit truncated after the normalized truncation with a mantissa truncated by an alignment truncation, and store a result data obtained by concatenation in the second register as the truncation error.

According to certain embodiments, the accumulation result is normalized and truncated. That is, if there is a carry in the accumulation result, the accumulation result is normalized. Only the high bits of the alignment bits in the accumulation result are retained, the low bits of the mantissa are truncated and sent to the truncation error device where they are added to the previous truncation error resulting from alignment and truncation to form the truncation error. As shown in FIG. 3B, both data ‘A’ and ‘B’ have a mantissa bit width of 8 bits. Data alignment is performed on data ‘A’ and ‘B’. After the data alignment, the lower 4 bits of data ‘B’ are excluded from the calculation and are truncated and stored in the truncation error register. The truncated data is then accumulated to obtain the accumulation result. When normalizing the accumulation result ‘C’, only the highest 8 bits of data are retained, and the low bit of the mantissa ‘3’ is truncated and stored in the truncation error register. This is used to calculate the truncation error for this accumulation and is carried over to the next calculation. The final calculation result is the high 8 bits output by the adder, and the output truncation error is the sum of the truncation error from alignment and the truncation error from data normalization.

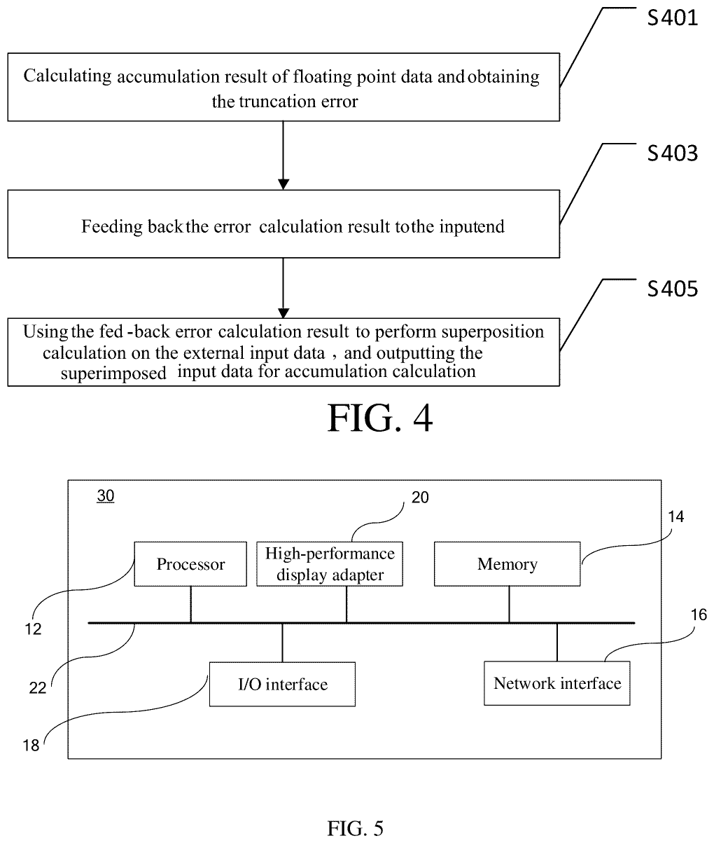

FIG. 4 shows a method flow diagram for an accumulator according to an example embodiment.

Referring to FIG. 4, in S401, the accumulation result of floating point data is calculated and the truncation error calculation result is obtained.

According to certain embodiments, in the adder, the accumulation result of floating point data is calculated, the truncation error is input into the truncation error device for calculation, and the calculation result is output and buffered in the second register.

In S403, the truncation error is fed back to the input end.

According to certain embodiments, the truncation error is output by the truncation error device and buffered into the second register, and then fed back to the difference correction module via the second register.

In S405, the fed-back truncation error is used to perform superposition calculation on the external input data, and the superimposed input data is output for accumulation calculation.

According to certain embodiments, the difference correction module uses the fed-back truncation error to perform superposition calculations on the external input data. The superimposed input data is then buffered into the third register and transferred to the accumulation execution module for further accumulation calculations.

During the accumulation process, the accumulation result and the superimposed input data are added together in alignment. The calculation result is used as the accumulation result, and the mantissa truncated by the alignment is used as the truncation error. If there is a carry in the accumulation result, the data is normalized and truncated. The low bits truncated after the normalized truncation and the mantissa truncated by the alignment truncation are concatenated to form the truncation error.

According to certain embodiments, the adder in the accumulation execution module calculates the sum of the superimposed result and the previous accumulation result. Using the method of alignment addition, the adder in the accumulation execution module performs alignment on the superimposed result and the previous accumulation result, truncates the mantissa, and accumulates the data after alignment. The adder outputs the accumulation result, and the truncated mantissa is taken as the truncation error. If a carry occurs in the accumulation result, the data is normalized and truncated. The high bits corresponding to the alignment digits are truncated as the output result, and the low bit of the mantissa is truncated and sent to the truncation error device. In the truncation error device, the alignment truncation error and the data normalized truncation error are added together to form the truncation error, which is then fed back to the difference correction module.

Only after the accumulation of all input data is completed, the accumulation result is rounded according to user requirements.

According to certain embodiments, in the accumulation execution module, the method of alignment addition is used in the accumulation calculation of each input data. When the final accumulation is completed, the adder rounds the accumulation result according to the user-defined number of decimal places for the floating-point data, and then returns the data that meets the requirements to the computer.

According to certain embodiments, the implementation of the accumulator is based on a chip circuit. The chip circuit can implement various functions including the aforementioned difference correction module and accumulation execution module, and realize the function of performing accumulation calculations on input data through the method of superimposing truncation errors on the input data.

According to certain embodiments, the accumulation operation in the accumulator only uses alignment truncation and concatenation circuits to obtain the error value. Compared with existing methods, this greatly reduces the requirements for hardware circuits, simplifies circuit complexity, and improves accumulation calculation efficiency.

According to certain embodiments, the accumulator constructs an adder that outputs both the accumulation result and the error value simultaneously during the accumulation and summation calculation process. This avoids the need for multiple subtraction operations to determine the error value, as is common in various existing algorithms. This not only simplifies the circuit design but also reduces the waste of computer resources and enhances the speed of accumulation operations.

FIG. 5 shows a block diagram of a computation device according to an exemplary embodiment.

As shown in FIG. 5, computation device 30 includes processor 12 and memory 14. computation device 30 may also include bus 22, network interface 16, and I/O interface 18. Processor 12, memory 14, network interface 16, and I/O interface 18 may communicate with each other via bus 22.

The processor 12 may include one or more general-purpose CPUs (Central Processing Units, processors), microprocessors, or application-specific integrated circuits, etc., for executing relevant program instructions. According to certain embodiments, computation device 30 may also include a high-performance display adapter (GPU) 20 to accelerate processor 12.

Memory 14 may include machine system readable medium in the form of volatile memory, such as random access memory (RAM), read only memory (ROM), and/or cache memory. Memory 14 is used to store one or more programs containing instructions and data. The processor 12 can read the instructions stored in the memory 14 to execute the above-mentioned method according to the embodiment of the present application.

computation device 30 may also communicate with one or more networks through network interface 16. The network interface 16 may be a wireless network interface.

The bus 22 may include an address bus, a data bus, a control bus, etc. Bus 22 provides a path for exchanging information between components.

It should be noted that during specific implementation, computation device 30 may also include other components necessary for normal operation. In addition, those skilled in the art can understand that the above-mentioned device may only include components necessary to implement the embodiments of this disclosure, and does not necessarily include all components shown in the drawings.

The present application also provides a computer-readable storage medium on which a computer program is stored, which implements the steps of the above method when executed by a processor. Computer-readable storage medium may include, but is not limited to, any type of disk, including floppy disks, optical disks, DVDs, CD-ROMs, microdrives, and magneto-optical disks, ROM, RAM, EPROM, EEPROM, DRAM, VRAM, flash memory devices, magnetic cards or optical cards, nanosystems (including molecular memory ICs), network storage devices, cloud storage devices, or any type of medium or device suitable for storing instructions and/or data.

Embodiments of the present application also provide a computer program product. The computer program product includes a non-transitory computer-readable storage medium that stores a computer program. The computer program is operable to cause the computer to execute some or all steps of any of the methods described in the above method embodiments.

Those skilled in the art can clearly understand that the technical solution of the present application can be implemented by means of software and/or hardware. “Unit” and “module” in this disclosure refer to software and/or hardware that can complete specific functions independently or in cooperation with other components. The hardware can be, for example, a field programmable gate array, an integrated circuit, etc.

It should be noted that for the sake of simple description, the foregoing method embodiments are expressed as a series of action combinations. However, those skilled in the art should know that the present application is not limited by the described action sequence. Because in accordance with this application, certain steps may be performed in other orders or simultaneously. Secondly, those skilled in the art should also know that the embodiments described in the disclosure are preferred embodiments, and the actions and modules involved are not necessarily required for this application.

Each of the above embodiments is described with its own emphasis. For parts not detailed in a certain embodiment, please refer to the relevant descriptions in other embodiments.

In the several embodiments provided in the present application, it should be understood that the disclosed device can be implemented in other ways. For example, the device embodiments described above are only illustrative. For example, the division of units is only a logical function division. In actual implementation, there may be other division methods. For example, multiple units or components may be combined or integrated into another system, or some features can be ignored, or not implemented. On the other hand, the coupling or direct coupling or communication connection between each other shown or discussed may be implemented through some service interfaces, and the indirect coupling or communication connection of the devices or units may be in electrical or other forms.

A unit described as a separate component may or may not be physically separate. A component shown as a unit may or may not be a physical unit, that is, it may be located in one place, or it may be distributed to multiple network units. Some or all of the units can be selected according to actual needs to achieve the purpose of the solution of this embodiment.

In addition, each functional unit in each embodiment of the present application can be integrated into one processing unit, each unit can exist physically alone, or two or more units can be integrated into one unit. The above integrated units can be implemented in the form of hardware or software functional units.

Integrated units may be stored in a computer-readable memory when implemented as software functional units and sold or used as independent products. Based on this understanding, the technical solution of the present application can be embodied in the form of software product in essence or in the part that contributes to the existing technology or in all or part of the technical solution, and the computer software product is stored in a memory, which includes several instructions to cause a computer device (which can be a personal computer, a server or a network device, etc.) to execute all or part of the steps of the methods of various embodiments of the present application.

Each of the above embodiments is described with its own emphasis. For parts not detailed in a certain embodiment, please refer to the relevant descriptions in other embodiments.

Exemplary embodiments of the present application have been specifically shown and described above. It is to be understood that the present application is not limited to the detailed structures, arrangements, or implementation methods described herein. On the contrary, the present application is intended to cover various modifications and equivalent arrangements included within the spirit and scope of the appended terms.

What is claimed is:

1. An accumulator for floating-point number accumulation, characterized in that
the accumulator comprises an accumulation execution module, a difference correction module and a first register, wherein:
the accumulation execution module is used to perform an accumulation operation on a floating-point type input data, and a truncated data in each operation is reserved as a truncation error, and the truncation error is fed back to the difference correction module;
the difference correction module uses the fed-back truncation error to perform a superposition calculation on an external input data, and outputs a superimposed input data to the accumulation execution module; and
the first register is used to buffer an accumulation result of the accumulation execution module, and the accumulation result is sent back to the accumulation execution module through a feedback channel.

2. The accumulator according to claim 1, characterized by
further comprising: a second register for buffering the truncation error and providing the truncation error to the difference correction module.

3. The accumulator according to claim 1, characterized by
further comprising: a third register for buffering the superimposed input data and providing the superimposed input data to the accumulation execution module.

4. The accumulator according to claim 2, characterized in that
the accumulation execution module is configured to align the accumulation result with the superimposed input data;
store a truncated mantissa during the alignment as the truncation error; and
perform an alignment addition on the truncated floating-point data, and buffer a result as the accumulation result into the first register.

5. The accumulator according to claim 4, characterized in that
the accumulation execution module comprises:
an adder used to perform an addition operation on the accumulation result and the superimposed input data; and
a truncation error register used to store the truncation error calculation result.

6. The accumulator according to claim 5, characterized in that
the accumulation execution module is configured to
in response to the accumulation result exceeding a number of alignment bits, perform a normalized truncation on the accumulation result, and truncate a high-bit data of corresponding alignment bits as the accumulation result and store the accumulation result in the first register;
concatenate a low bit truncated after the normalized truncation with a mantissa truncated by an alignment truncation, and store a result data obtained by the concatenation in the second register as the truncation error.

7. A method for an accumulator, characterized in that
the method comprises:
calculating an accumulation result of a floating point data and obtaining a truncation error;
feeding the truncation error back to an input end; and
using the fed-back truncation error to perform a superposition calculation on an external input data, and outputting the superimposed input data for accumulation calculation.

8. The method according to claim 7, characterized in that
the step of calculating an accumulation result of a floating point data and obtaining a truncation error comprises:
during the accumulation, performing an alignment addition on the accumulation result and the superimposed input data, using a calculation result as the accumulation result, and using a mantissa truncated by the alignment as the truncation error;
in response to there being a carry in the accumulation result, performing a normalized truncation on the data, and concatenating a low bit truncated after the normalized truncation with the mantissa truncated by the alignment truncation to form the truncation error; and
only after the accumulation is completed, performing a rounding operation on the accumulation result.

9. A chip circuit, characterized by comprising:
the accumulator according to claim 1.

10. A chip circuit, characterized by comprising:
the accumulator according to claim 2.

11. A chip circuit, characterized by comprising:
the accumulator according to claim 3.

12. A chip circuit, characterized by comprising:
the accumulator according to claim 4.

13. A chip circuit, characterized by comprising:
the accumulator according to claim 5.

14. A chip circuit, characterized by comprising:
the accumulator according to claim 6.
